(19) United States
(12) Patent Application Publication
(10) Pub. No.: US 2017/0060774 A1
(43) Pub. Date: Mar. 2, 2017

(54) STORAGE CONTROL DEVICE

(71) Applicant: FUJITSU LIMITED, Kawasaki-shi (JP)

(72) Inventors: Mikio ITO, Kawasaki (JP); Yuji Morita, Shinagawa (JP); Takako Kato, Setagaya (JP); Osamu Kimura, Kawasaki (JP)

(73) Assignee: FUJITSU LIMITED, Kawasaki-shi (JP)

(21) Appl. No.: 15/244,705

(22) Filed: Aug. 23, 2016

(30) Foreign Application Priority Data
Sep. 2, 2015 (JP) 2015-172543

(51) Int. Cl. G06F 12/128; G06F 12/1018

(52) U.S. Cl. CPC G06F 12/128; G06F 12/1018; G06F 2212/69

(57) ABSTRACT

A storage control device includes a first memory, a second memory, and a processor. The processor is configured to store a reference count of each of a plurality of first and second unit data. The processor is configured to arrange first entries of first management information in a first memory area on the first memory. The first entries each include a hash value and information indicating where corresponding one of the first unit data is stored. The processor is configured to arrange second entries of second management information in a second memory area on the second memory. The second entries each include a hash value, information indicating where corresponding one of the second unit data is stored, and the reference count. The processor is configured to arrange, in a third memory area on the first memory, index information for filtering hash values included in the second entries.

### CROSS-REFERENCE TO RELATED APPLICATION

This application is based upon and claims the benefit of priority from the prior Japanese Patent Application No. 2015-172543 filed on Sep. 2, 2015, the entire contents of which are incorporated herein by reference.

### FIELD

The embodiment discussed herein is related to a storage control device.

### BACKGROUND

An increase in an amount of data dealt in a business or the spread of virtual environments has been accompanied by a significant increase in a use amount of storage (storage device). Accordingly, a data redundancy elimination function may be adopted in a storage system in order to make it possible to efficiently use a limited storage capacity. Here, the storage is a drive such as a hard disk drive (HDD) or a solid state drive (SSD).

In a storage control device equipped with the data redundancy elimination function, a hash value (also referred to as a fingerprint), which is a feature amount for unit data to be written, is calculated when the unit data is to be written in the storage. Then, a determination of whether the unit data to be written corresponds to existing data or new data is performed by comparing the calculated hash value with a hash value of unit data already stored in the storage to determine consistency/inconsistency therebetween.

The hash value of the already stored unit data has been registered in a hash value search table (also referred to as a hash cache) for data redundancy elimination in association with a physical address of a write destination of the corresponding unit data. The information of the hash value search table for data redundancy elimination is saved in a memory for storage control in a storage control device.

According to the determination result, when it is determined that the unit data to be written corresponds to existing data, the unit data to be written is not allowed to be written in the storage, and thus, the data redundancy elimination is performed. When it is determined that the unit data to be written corresponds to new data, a physical address of a write destination within the storage is allocated to the unit data, and the unit data is written at the allocated physical address. In addition, in the storage control device, the hash value calculated for the unit data to be written and the allocated physical address are associated with each other to be additionally registered in the hash value search table for data redundancy elimination.

Related techniques are disclosed in, for example, Japanese Laid-Open Patent Publication No. 2009-251725, Japanese Laid-Open Patent Publication No. 2014-130549, and Japanese National Publication of International Patent Application No. 2013-508810.

The information of the hash value search table for data redundancy elimination is saved in a memory within the storage control device, rather than in the storage (a drive such as an HDD or an SSD) to be controlled by the storage control device. This is because an access cost for a case where the information is saved in the drive significantly affects the performance of the storage system. Hereinafter, the hash value search table for data redundancy elimination may be referred to as management information, a management table, or a hash cache.

In consideration of the memory cost of the storage system, the size of the table may be made as small as possible to reduce the memory cost. However, when the size of the table is made smaller, the number of hash values to be registered in the table is decreased, and thus, even when the table is searched for the hash value of the unit data to be written, the likelihood of a cache hit becomes low. That is, the possibility of detecting redundant data becomes low. As a result, the efficiency of data redundancy elimination is reduced, and thus, a limited storage capacity may not be efficiently utilized.

### SUMMARY

According to an aspect of the present invention, provided is a storage control device including a first memory, a second memory different from the first memory, and a processor. The processor is configured to store, in a storage device, a reference count of each of a plurality of first unit data and each of a plurality of second unit data. The reference count indicates a number of times of writing the respective unit data in the storage device. The processor is configured to arrange first entries of first management information in a first memory area on the first memory. The first memory area has a predetermined size. The first entries each include a hash value and information indicating where corresponding one of the plurality of first unit data is stored in the storage device. The processor is configured to arrange second entries of second management information in a second memory area on the second memory. The second entries each include a hash value, information indicating where corresponding one of the plurality of second unit data is stored in the storage device, and the reference count regarding the corresponding one of the plurality of second unit data. The processor is configured to arrange, in a third memory area on the first memory, index information for filtering hash values included in the second entries.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an exemplary hardware configuration of a storage apparatus including storage control devices according to an embodiment;

FIG. 2 is a diagram illustrating an exemplary functional configuration of the storage control device according to the embodiment;

FIG. 3 is a diagram illustrating information stored in a memory area (first memory area) for a first hash cache and a memory area for upper-level index information in a memory (first memory) according to the embodiment;

FIG. 4 is a diagram illustrating information stored in a memory area (second memory area) for a second hash cache, a memory area for upper-level index information, and a memory area for lower-level index information in a storage device (second memory) according to the embodiment;

FIG. 5 is a diagram illustrating operations of the storage control device according to the embodiment;

FIG. 6 is a diagram illustrating operations of the storage control device according to the embodiment;

FIG. 7 is a diagram illustrating operations of the storage control device according to the embodiment;

FIG. 8 is a flowchart illustrating a redundancy elimination search procedure according to a related technique which is compared with the embodiment;

FIG. 9 is a flowchart illustrating a redundancy elimination search procedure according to the embodiment at the time of a write operation;

FIG. 10 is a flowchart illustrating a redundancy elimination search procedure according to the embodiment at the time of a write operation;

FIG. 11 is a flowchart illustrating a redundancy elimination search procedure according to the embodiment at the time of a write operation;

FIG. 12 is a flowchart illustrating a hash value registration procedure according to the embodiment; and

FIG. 13 is a flowchart illustrating a hash value registration procedure according to the embodiment.

### DESCRIPTION OF EMBODIMENT

Hereinafter, description will be made on an embodiment of a storage control device in detail with reference to the accompanying drawings. The embodiment described later is just illustrative only and it is not intended to exclude application of various modifications and techniques which is not clarified in the embodiment. That is, various modifications according to the embodiment may be embodied in a range without departing from a gist of the present disclosure. Respective drawings may include other functional components without being construed as including only the constitutional elements illustrated in the drawings. Respective modified embodiments may be combined with each other as long as inconsistency of processing is not caused.

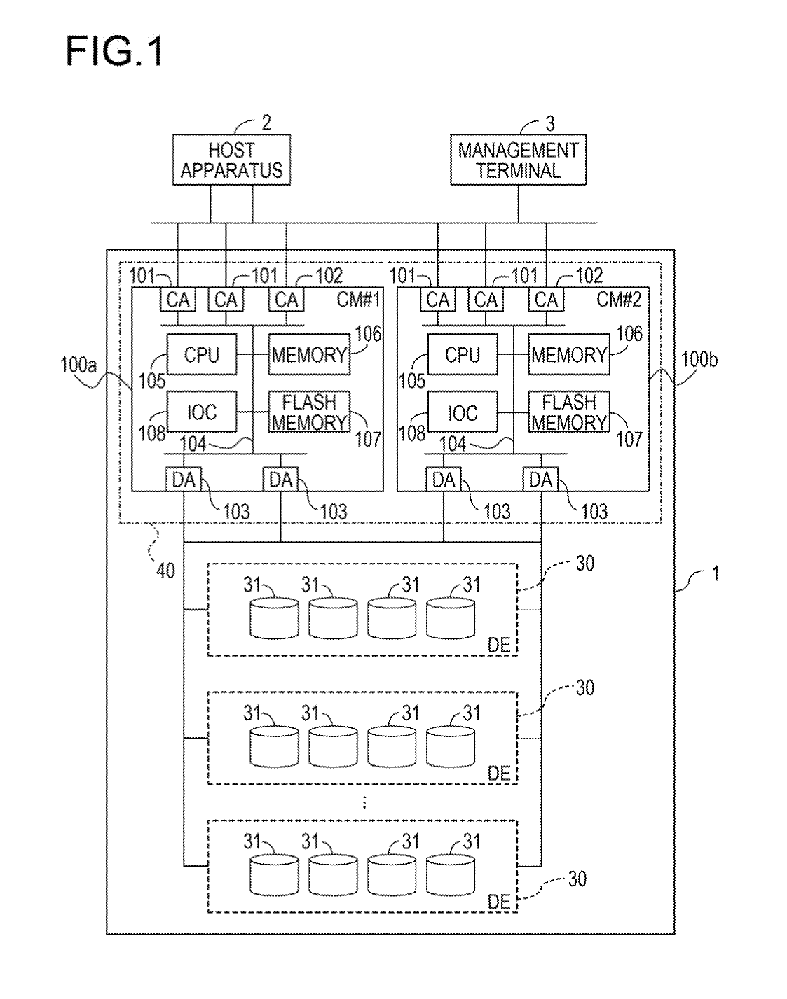

First, descriptions will be made on a storage apparatus 1 including storage control devices 100 (100a, 100b) according to the embodiment with reference to FIG. 1. FIG. 1 is a diagram illustrating an exemplary hardware configuration of the storage apparatus 1 including the storage control devices 100 (100a, 100b) according to the embodiment.

The storage apparatus 1 virtualizes storage devices 31 (second memory) stored in a drive enclosure (DE) 30 to form a virtual storage environment. Thus, the storage apparatus 1 provides virtual volumes to a host apparatus 2 which is an upper-level apparatus.

The storage apparatus 1 is communicably connected with at least one (one in the example illustrated FIG. 1) host apparatus 2. The host apparatus 2 and the storage apparatus 1 are connected to each other through communication adapters (CAs) 101 and 102.

The host apparatus 2 is an information processing apparatus equipped with, for example, a server function and transmits and receives a command of network attached storage (NAS) or a storage area network (SAN) to and from the storage apparatus 1. The host apparatus 2 transmits, for example, a storage access command such as read/write in the NAS to the storage apparatus 1 to write or read data to or from a volume provided by the storage apparatus 1.

In accordance with an input/output request (e.g., a read command or a write command) made from the host apparatus 2 with respect to a volume, the storage apparatus 1 performs processing such as data reading or writing for a storage device 31 corresponding to the volume. The input/output request made from the host apparatus 2 may be referred to as an IO request or an IO command.

Although the example of FIG. 1 represents a single host apparatus 2, the number of host apparatuses is not limited thereto, and two or more host apparatuses 2 may be connected to the storage apparatus 1.

In addition, a management terminal 3 is communicably connected to the storage apparatus 1. The management terminal 3 is an information processing apparatus provided with an input device such as a keyboard or a mouse, or a display device, and allows a user (e.g., a system administrator) to perform an input operation of various pieces of information. For example, the user inputs information relating to various settings through the management terminal 3. The input information is transmitted to the host apparatus 2 or the storage apparatus 1.

As illustrated in FIG. 1, the storage apparatus 1 includes a plurality of (two in the example illustrated FIG. 1) controller modules (CMs) 100a and 100b and one or more (three in the example illustrated FIG. 1) drive enclosures 30.

Each drive enclosure 30 is capable of mounting therein one or more (four in the example illustrated FIG. 1) storage devices 31 (physical disks) and provides a storage area (real volume or real storage) of the storage device 31 to the storage apparatus 1.

For example, the drive enclosure 30 may include a plurality of slots (not illustrated), and the storage devices 31 are inserted into the slots such that the actual volume capacity may be changed appropriately. It is possible to configure a redundant array of inexpensive disks (RAID) by using the plurality of storage devices 31.

The storage device 31 (second memory) is a storage device (storage) such as an HDD or an SSD having a capacity larger than that of a memory 106 which will be described later, and stores various data. In the following descriptions, the storage device may be referred to as a drive or a disk.

Each drive enclosure 30 is connected to respective device adapters (DAs) 103 of the CM 100a and respective DAs 103 of the CM 100b. Each drive enclosure 30 is accessible from both of the CMs 100a and 100b to be subjected to the data reading or writing. That is, each of the CMs 100a and 100b is connected to each storage device 31 of the drive enclosure 30 such that an access path to the storage device 31 is made redundant.

The controller enclosure 40 includes one or more (two in the example illustrated FIG. 1) CMs 100a and 100b.

The CMs 100a and 100b are controllers (storage control devices) to control operations performed within the storage apparatus 1 and perform various controls such as the control for data access to the storage devices 31 in the drive enclosures 30, in accordance with the IO command transmitted from the host apparatus 2. The CMs 100a and 100b have an identical configuration with each other. Hereinafter, the respective CM is may be referred to as the CM 100a or the CM 100b when one of the plurality of CMs is specified, and referred to as the CM 100 when indicating any of the CMs. Further, the CM 100a and the CM 100b may be denoted by CM#1 and CM#2, respectively.

The CMs 100a and 100b are duplicated, and normally, the CM 100a (CM#1) serves as a primary CM to perform various controls. When the primary CM 100a fails, a secondary CM 100b (CM#2) takes over the operations of the CM 100a to serve as a primary CM.

Each of the CMs 100a and 100b is connected to the host apparatus 2 through CAs 101 and 102. The CMs 100a and 100b receive an IO command such as read/write transmitted from the host apparatus 2, and controls the storage device 31 through, for example, the DAs 103. The CMs 100a and 100b are communicably connected with each other through an interface such as a peripheral component interconnect express (PCIe) (not illustrated).

As illustrated in FIG. 1, the CM 100 includes a central processing unit (CPU) 105, a memory 106, a flash memory 107, and an input/output controller (IOC) 108, in addition to the CAs 101 and 102 and a plurality of (two in the example illustrated FIG. 1) DAs 103. The CAs 101 and 102, the DAs 103, the CPU 105, the memory 106, the flash memory 107, and the IOC 108 are communicably connected with each other through, for example, a PCIe interface 104.

The CAs 101 and 102 receive data transmitted from, for example, the host apparatus 2 or the management terminal 3, or transmit data output from the CM 100 to the host apparatus 2 or the management terminal 3. That is, the CAs 101 and 102 control the input and output (10) of data performed between the storage control device and an external apparatus such as the host apparatus 2.

The CA 101 is a network adapter communicably connected with the host apparatus 2 or the management terminal 3 via the NAS and is, for example, a local area network (LAN) interface. Each CM 100 is connected to, for example, the host apparatus 2 using the CAs 101 through a communication line (not illustrated) via the NAS, and performs, for example, reception of the IO command and transmission/reception of data. In the example illustrated in FIG. 1, two CAs 101 are included in each of the CMs 100a and 100b.

The CA 102 is a network adapter communicably connected with the host apparatus 2 via the SAN and is, for example, an internet small computer system interface (iSCSI) or a fibre channel (FC) interface. Each CM 100 is connected to, for example, the host apparatus 2 using the CA 102 through a communication line (not illustrated) via the SAN, and performs, for example, reception of the IO command and transmission/reception of data. In the example illustrated in FIG. 1, a single CA 102 is included in each of the CMs 100a and 100b.

The DA 103 is an interface communicably connected with, for example, the drive enclosure 30 or the storage device 31. The storage device 31 of the drive enclosure 30 is connected to the DA 103, and each CM 100 performs access control for the storage device 31 in accordance with the IO command received from the host apparatus 2.

Each CM 100 performs data reading or writing for the storage device 31 through the DA 103. In the example illustrated in FIG. 1, two DAs 103 are included in each of the CMs 100a and 100b. Also, the drive enclosures 30 are connected to the respective DAs 103 in each of the CMs 100a and 100b.

Accordingly, the storage device 31 of the drive enclosure 30 is capable of being subjected to data reading or writing by both CMs 100a and 100b.

The flash memory 107 is a storage device that stores a program executed by the CPU 105 or various data.

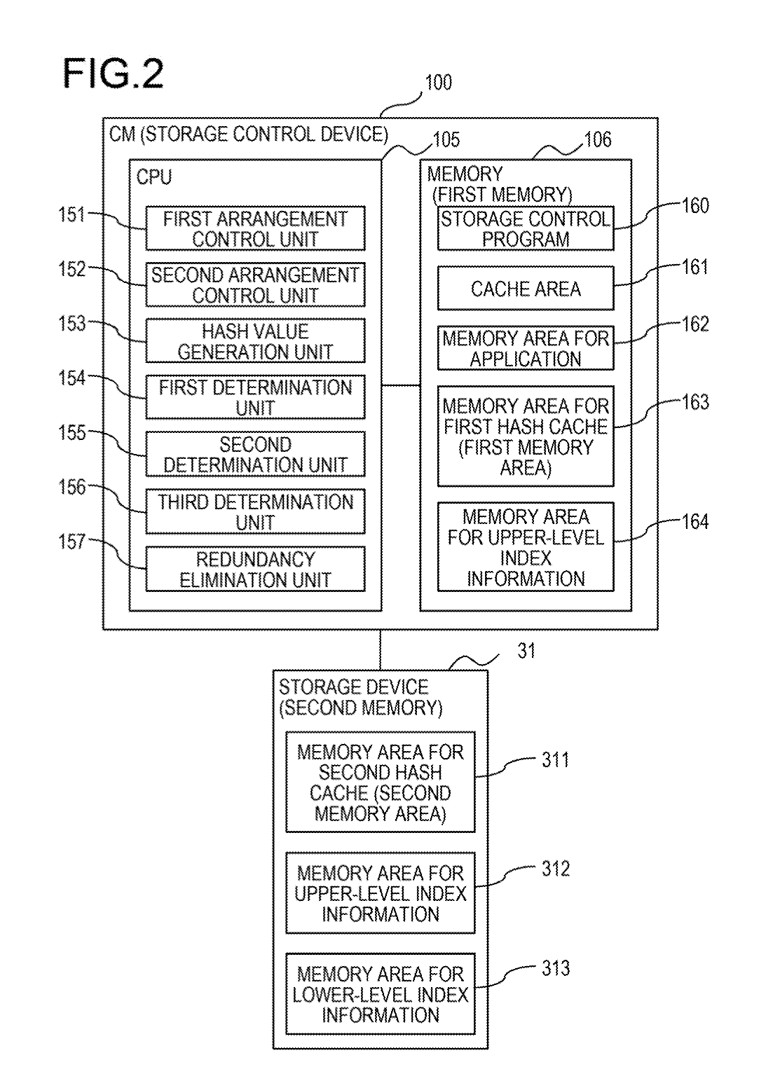

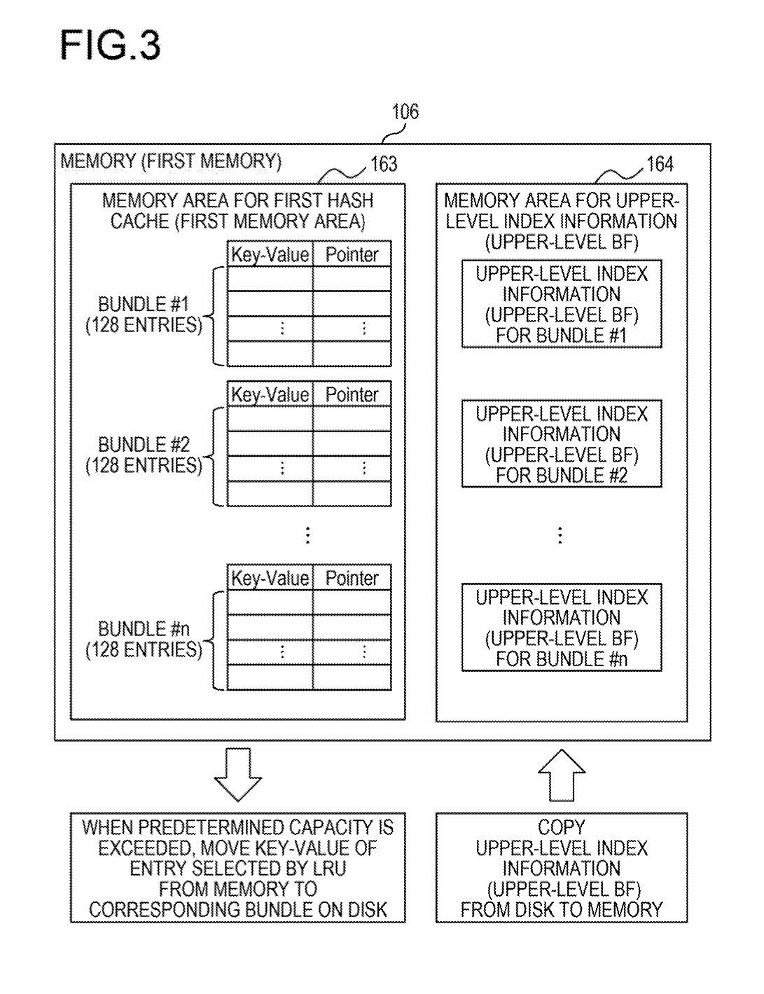

The memory 106 (first memory) is a storage device that temporarily stores various data or programs and includes a cache area 161 or memory areas 162,163, and 164 that will be described later (see FIGS. 2 and 3). The cache area 161 temporarily stores data received from the host apparatus 2 and data to be transmitted to the host apparatus 2. The memory area 162 for application temporarily stores data or programs used when an application program is executed by the CPU 105. The application program is, for example, a storage control program 160 executed by the CPU 105 in order to realize the storage control function according to the embodiment, and the storage control program 160 is saved in the memory 106 or the flash memory 107. Details of the memory areas 163 and 164 will be described later with reference to FIGS. 2 and 3. The memory 106 (first memory) is, for example, a random access memory (RAM) having a higher access speed but a smaller capacity than those of the storage device 31 (second memory or drive) described above.

The IOC 108 is a control device that controls a data transmission within each CM 100 and implements, for example, a direct memory access (DMA) transmission in which data stored in the memory 106 is transmitted without using the CPU 105.

The CPU 105 is a processor that performs various controls or operations and is, for example, a multi-core processor (multi-CPU). The CPU 105 executes an operating system (OS) and a program stored in, for example, the memory 106 or the flash memory 107 to implement various functions.

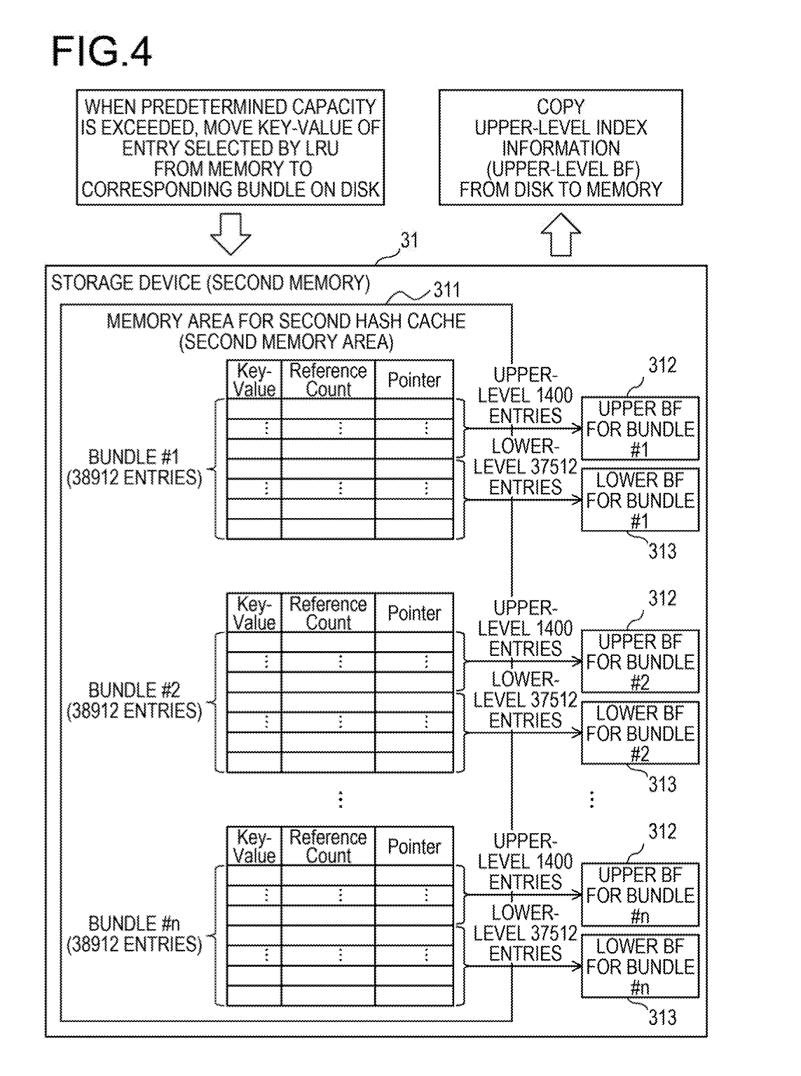

Next, descriptions will be made on a functional configuration of the storage control device 100 (CM) according to the embodiment with reference to FIGS. 2 to 4. FIG. 2 is a diagram illustrating an exemplary functional configuration of the CM 100. FIG. 3 is a diagram illustrating information stored in a memory area 163 (first memory area) for a first hash cache and a memory area 164 for upper-level index information on the memory 106 (first memory) according to the embodiment. FIG. 4 is a diagram illustrating information stored in a memory area 311 (second memory area) for a second hash cache, a memory area 312 for upper-level index information, and a memory area 313 for lower-level index information on the drive 31 (second memory) according to the embodiment.

The CM 100 according to the embodiment has a function (data redundancy elimination function) to eliminate redundancy of respective unit data to be saved in each storage device 31 by controlling each storage device 31 in the DE 30. In a case where unit data to be written, which is received from the host apparatus 2, is written into the cache area 161 on the memory 106 so as to be written into the storage device 31, the CM 100 performs a basic redundancy elimination operation using the data redundancy elimination function as follows.

That is, a hash value (fingerprint) which is a feature amount regarding the unit data to be written is generated in the CM 100. Then, a determination of whether the unit data to be written corresponds to existing data or new data is performed by comparing the generated hash value with a hash value of unit data already stored in the storage device 31 to determine consistency/inconsistency therebetween. According to the determination result, when it is determined that the unit data to be written corresponds to existing data, the unit data to be written is not allowed to be written in the storage device 31, and thus, the data redundancy elimination is performed. The functions or the operations of the CM 100 according to the embodiment related to a case where it is determined that the unit data to be written corresponds to new data will be described later.

The hash value of the unit data already stored in the storage device 31 is registered, as described later, in a first hash cache on the memory 106 or a second hash cache on the drive 31 in association with a physical address (physical storage information) of a write destination of the relevant unit data. The hash cache may be referred to as a hash value search table for data redundancy elimination. The information of the first hash cache is saved in the memory area 163 (first memory area) on the memory 106 for storage control in the CM 100. The information of the second hash cache is saved in the memory area 311 (second memory area) on the drive 31.

Here, descriptions will be made on the first hash cache (on-memory table) which is saved in the memory area 163 on the memory 106 with reference to FIG. 3. As illustrated in FIG. 3, n bundles #1 to #n (n is an integer of two or more, for example, n=262144) are included in the first hash cache. Each bundle includes, for example, 128 entries. Each entry includes a Key-Value and a pointer. The Key is a hash value (e.g., 20 bytes). The Value includes a container (ID) (4 bytes) and a slot number (4 bytes) corresponding to the physical storage information (physical address) indicating a storing destination among the drives 31. The pointer includes a forward pointer (2 bytes) and a backward pointer (2 bytes), and configures a link within the 128 entries.

In the first hash cache illustrated in FIG. 3, in a case where a new hash value is additionally registered (stored) in an empty entry or in a case where search in the first hash cache is performed using the hash value (searched hash value) for search, the remainder operation (mod operation) of the hash value (key value) is performed. That is, a search bundle is determined based on a remainder obtained by dividing the hash value by the total number of bundles n. In a case where a new hash value is additionally registered in a state where the hash values are registered in all of entries in the search bundle, a Key-Value of a top-most (oldest) entry determined by using a least recently used (LRU) algorithm is expelled from the first hash cache. The expelled Key-Value is moved from the memory 106 to a corresponding bundle of the second hash cache on the drive 31 (on the disk), and a new Key-Value is stored in the top-most entry. In a case where the new hash value is stored or in a case where the searched hash value is hit, the corresponding entry is linked to the bottom-end of the bundle by the pointer. In the following descriptions, a bundle on the drive 31, which corresponds to the search bundle in the first hash cache, may be referred to as a corresponding bundle.

Next, descriptions will be made on a second hash cache (on-disk table) saved in the memory area 311 on the drive 31 with reference to FIG. 4. As illustrated in FIG. 4, n bundles #1 to #n that respectively correspond to the n bundles in the first cache hash illustrated in FIG. 3, are stored in the second hash cache. Each bundle includes, for example, 38912 entries. Each entry includes a Key-Value, a reference count, and a pointer. The Key-Value is, as described above, a Key-Value overflowed from the bundle in the first hash cache by using the LRU algorithm. The reference count is, for example, the number of times of redundant references counted by a reference counter during a write sequence for each unit data and corresponds to information indicating the degree of redundancy of each unit data. The reference count of each unit data is saved in a predetermined container (drive 31). When the Key-Value overflowed from the first hash cache is registered in the second hash cache, the reference count of the unit data corresponding to the Key-Value is read out from the predetermined container and registered in the corresponding entry. The entries within each bundle of the second hash cache are sorted in descending order of the reference count.

Next, with reference to FIG. 4, descriptions will be made on upper-level index information and lower-level index information (on-disk index) that are respectively saved in a memory area 312 and a memory area 313 on the drive 31. The upper-level index information and the lower-level index information are prepared for the respective n bundles #1 to #n.

As illustrated in FIG. 4, the upper-level index information for the bundle #i (i is an integer of 1 to n) is information for searching among upper-level entries having a reference count greater than or equal to a criterion value among entries of the bundle #i in the second hash cache. The upper-level index information for the bundle #i may be information for searching among a criterion number (e.g., 1400 entries) of upper-level entries existing in the upper-level side among the entries of the bundle #i in the second hash cache. For example, the upper-level index information (hereinafter, may be referred to as an upper-level BF) is a Bloom filter prepared for filtering only the upper-level entries having the reference count greater than or equal to the criterion value. The determination as to whether the searched hash value is included in the upper-level entries of the bundle #i or not may be quickly performed by allowing the searched hash value to pass through the upper-level BF for bundle #i. When it is determined that the searched hash value is included in the upper-level entries of the bundle #i, by the upper-level BF, it may be an erroneous detection by false positive. For that reason, search for the hash value among the upper-level entries of the bundle #i is performed, and thus, it is checked whether the searched hash value is actually included in the upper-level entries of the bundle #i. The upper-level BF for the bundles #1 to #n saved in the memory area 312 on the drive 31 as described above is copied from the drive 31 to a memory area 164 for the upper-level BF on the memory 106. For example, the size of a single BF is 4 KB, and entries of physical capacity 5.6 MB may be allowed to be filtered by the BF of 4 KB.

The lower-level index information for the bundle #i is information for searching among lower-level entries having a reference count less than the criterion value among the entries of the bundle #i in the second hash cache. The lower-level index information for the bundle #i may be information for searching among the remaining number (e.g., 37512 entries) of lower-level entries, except for the criterion number of upper-level entries existing in the upper-level side, among the entries of the bundle #i in the second hash cache. For example, the lower-level index information (hereinafter, may be referred to as a lower-level BF) is a Bloom filter prepared for filtering only the lower-level entries having the reference count less than the criterion value. The determination as to whether the searched hash value is included in the lower-level entries of the bundle #i or not may be quickly performed by allowing the searched hash value to pass through the lower-level BF for bundle #i. When it is determined that the searched hash value is included in the lower-level entries of the bundle #i by the lower-level BF, it may be an erroneous detection by false positive. For that reason, search for the hash value among the lower-level entries of the bundle #i is performed, and thus, it is checked whether the searched hash value is actually included in the lower-level entries of the bundle #i.

Descriptions will be made on the upper-level index information (on-memory index) saved in the memory area 164 on the memory 106 with reference to FIG. 3. As illustrated in FIG. 3, the upper-level BF for the bundles #1 to #n saved in the drive 31 is copied from the drive 31 to the memory area 164 for the upper-level BF on the memory 106 to be maintained also in the memory 106.

In the CM 100 according to the embodiment, the CPU 105 refers to the first hash cache and the upper-level BF on the memory 106 and also refers to the second hash cache and the lower-level BF on the drive 31 as needed, thereby functioning as follows. That is, as illustrated in FIG. 2, the CPU 105 executes the storage control program 160 so as to function as a first arrangement control unit 151, a second arrangement control unit 152, a hash value generation unit 153, a first determination unit 154, a second determination unit 155, a third determination unit 156, and a redundancy elimination unit 157.

The storage control program 160 is provided by being recorded in a non-transitory portable computer-readable recording medium. The computer-readable recording medium may include, for example, a magnetic disk, an optical disk, and a magneto-optical disk. The optical disk may include, for example, a compact disk (CD), a digital versatile disk (DVD), and a Blu-ray disk. The CD includes, for example, a CD read-only memory (CD-ROM) or CD recordable/rewritable (CD-R/RW). The DVD includes, for example, a DVD-RAM, a DVD-ROM, a DVD-R, a DVD+R, a DVD-RW, a DVD+RW, and a high definition (HD) DVD.

The CPU 105 reads the storage control program 160 from the recording medium as described above, and stores the storage control program 160 in an internal storage device (e.g., the memory 106 or the flash memory 107) or an externally attached storage device to execute the program. The CPU 105 may receive the storage control program 160 through a network (not illustrated) and store the storage control program 160 in the internal storage device or the externally attached storage device to execute the program.

The first arrangement control unit 151 arranges, for each of the bundles, the first hash cache (first management information), which includes the hash value and the physical address for each unit data stored in each drive 31 in the DE 30, in the first memory area 163 having a predetermined size. In the embodiment, for example, the capacity of 128 entries is set as the predetermined size for each bundle. In the embodiment, the unit data for which a hash value is to be calculated may be either a data block having a size of a unit (physical block; e.g., 512 B (bytes)) for writing into, for example, an HDD or an SSD, or a data block group (e.g., 4 K (bytes)) formed by integrating a plurality of data blocks into a single group.

The second arrangement control unit 152 arranges, as an entry of the second hash cache (second management information), the Key-Value of an entry of the first management information, which runs over the predetermined size of each bundle by using the LRU, in the second memory area 311 on the drive 31, which is different from first memory area 163. In this case, the second arrangement control unit 152 reads the reference count of the unit data corresponding to the overflowed entry from a predetermined container, registers the reference count in the corresponding entry of the second hash cache, and sorts the entries within the corresponding bundle in descending order of the reference count.

The second arrangement control unit 152 arranges the index information (BF), which is prepared to search the second hash cache for the hash value, for each bundle, in the memory area 164 for upper-level index information on the memory 106 including the first memory area 163. In this case, the second arrangement control unit 152 arranges, as the index information, the upper-level BF for quickly filtering the hash values of the upper-level entries of the second hash cache, which corresponds to the upper-level unit data having the reference count greater than or equal to the criterion value, in the memory area 164 on the memory 106. The second arrangement control unit 152 arranges the upper-level BF for each bundle in the memory area 312 for the upper-level index information on the drive 31 and arranges the copy of the upper-level BF arranged in the memory area 312 in the memory area 164 on the memory 106.

In addition, the second arrangement control unit 152 arranges the lower-level BF for quickly filtering the hash values of the lower-level entries corresponding to the lower-level unit data having the reference count less than the criterion value, in the memory area 313 for lower-level index information on the drive 31 including the second memory area 311.

When the unit data to be written, which is received from the host apparatus 2, is written into the cache area 161 on the memory 106, the hash value generation unit 153 generates a searched hash value for the unit data to be written. An algorithm used for calculating the hash value by the hash value generation unit 153 may include, for example, a message-digest (MD) 5, a secure hash algorithm (SHA)-1, or a SHA-256.

The first determination unit 154 searches the first hash cache on the memory 106 for the searched hash value generated by the hash value generation unit 153 to determine whether the searched hash value is included in the first hash cache. At this time, the first determination unit 154 performs the remainder operation of the searched hash value, determines the search bundle, and searches for the searched hash value among the entries of the determined search bundle.

When the first determination unit 154 determines that the searched hash value is not included in the first hash cache, the second determination unit 155 refers to the upper-level BF for the search bundle on the memory 106 regarding the searched hash value. The second determination unit 155 determines whether the searched hash value is included in the upper-level entries of the second hash cache on the drive 31 by allowing the searched hash value to pass through the upper-level BF for the search bundle.

When it is determined, by using the upper-level BF, that the searched hash value is included in the upper-level entries of the second hash cache, it may be an erroneous detection by false positive. For that reason, the second determination unit 155 reads the upper-level entries of the search bundle from the second hash cache on the drive 31 into the memory area 162 for application on the memory 106. Then, the second determination unit 155 searches for the searched hash value among the read upper-level entries to check whether any of the hash values in the upper-level entries matches the searched hash value.

When the second determination unit 155 determines that the searched hash value is not included in the upper-level entries of the second hash cache, the third determination unit 156 reads the lower-level BF for the corresponding bundle from the memory area 313 on the drive 31 into the memory area 162 for application on the memory 106. The third determination unit 156 determines whether the searched hash value is included in the lower-level entries of the second hash cache on the drive 31 by allowing the searched hash value to pass through the read lower-level BF for the corresponding bundle.

When it is determined, by using the lower-level BF, that the searched hash value is included in the lower-level entries of the second hash cache, it may be an erroneous detection by false positive. For that reason, the third determination unit 156 reads the lower-level entries of the search bundle from the second hash cache on the drive 31 into the memory area 162 for application on the memory 106. Then, the third determination unit 156 searches for the searched hash value among the read lower-level entries to check whether any of the hash values in the lower-level entries matches the searched hash value.

In any one case of the following (a1), (a2), and (a3), the redundancy elimination unit 157 performs a redundancy elimination procedure for the unit data to be written:

(a1) a case where the first determination unit 154 determines that the searched hash value is included in the first hash cache,

(a2) a case where the second determination unit 155 determines that the searched hash value is included in the upper-level entries of the second hash cache, and

(a3) a case where the third determination unit 156 determines that the searched hash value is included in the lower-level entries of the second hash cache.

The first arrangement control unit 151 and the second arrangement control unit 152 operate as follows in the following case (b1) or (b2):

(b1) a case where the third determination unit 156 determines that the searched hash value is not included in the lower-level entries of the second hash cache, and an empty entry is not present in the search bundle of the first memory area 163, and

(b2) a case where the first determination unit 154 determines that the searched hash value is not included in the first hash cache, that an empty entry is not present in the search bundle of the first memory area 163, and that the second hash cache is in an empty state or is not present:

In the case of (b1) or (b2), the second arrangement control unit 152 additionally registers one hash value (Key) in the search bundle of the first hash cache in the second hash cache on the drive 31. The one hash value is selected by using the LRU algorithm. The second arrangement control unit 152 refers to the reference count (the number of times of redundant references), which is saved in the predetermined container, for the unit data corresponding to the one hash value. When the referred-to reference count is greater than or equal to the criterion value, the second arrangement control unit 152 registers the one hash value in the upper-level BF for the corresponding bundle and updates the upper-level BF for the corresponding bundle on the memory 106 and the drive 31. At this time, the registration of the one hash value into the upper-level BF for the corresponding bundle is performed by preparing an upper-level BF for filtering upper-level entries including the one hash value.

In the case of (b1) or (b2), the first arrangement control unit 151 registers the searched hash value (Key), instead of the one hash value, in the first hash cache on the memory 106 in association with the physical address (Value) of the storing destination of the corresponding unit data. When the referred-to reference count is less than the criterion value, the second arrangement control unit 152 registers the one hash value in the lower-level index information for the corresponding bundle and updates the lower-level BF for the corresponding bundle on the drive 31. In this case, the registration of the one hash value into the lower-level BF for the corresponding bundle is performed by preparing a lower-level BF for filtering lower-level entries including the one hash value.

In a case where the first determination unit 154 determines that the searched hash value is not included in the first hash cache and that an empty entry exists in the first memory area 163 (entries of the search bundle), and the first arrangement control unit 151 additionally registers, in the first hash cache the searched hash value in an entry of the search bundle.

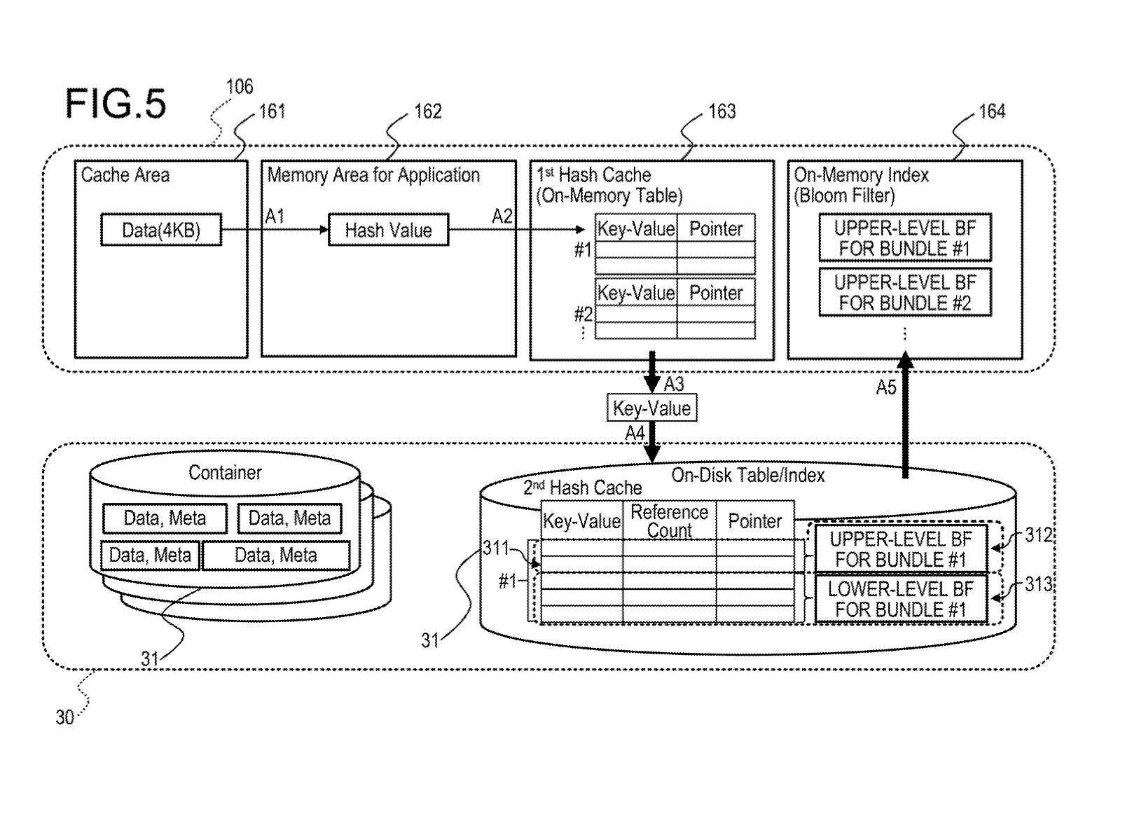

Next, descriptions will be made on operations of the storage control device 100 according to the embodiment with reference to FIGS. 5 to 7. FIGS. 5 to 7 are diagrams illustrating operations of the storage control device 100 according to the embodiment.

First, descriptions will be made on the basic operation of the CM 100 according to the embodiment with reference to FIG. 5. As illustrated in FIG. 5, when the unit data to be written is received from the host apparatus 2 and stored in the cache area 161 on the memory 106, the hash value of the unit data to be written is generated by the CPU 105 and saved in the memory area 162 for application (A1). Then, the remainder operation of the hash value is performed by the CPU 105, and the search bundle for the hash value is determined (A2).

In the CM 100 according to the embodiment, the first hash cache (on-memory table) for each of n bundles #1 to #n and the upper-level BF (on-memory index) for each of n bundles #1 to #n are arranged on the memory 106. Further, the second hash cache (on-disk table) for each of n bundles #1 to #n and the upper-level BF/the lower-level BF (on-disk index) for each of n bundles #1 to #n are arranged on the drive 31 (e.g., an HDD an SSD).

In a case where an empty entry does not exist in the entries of the search bundle when a new hash value is additionally registered in the search bundle of the first hash cache, that is, in a case where the search bundle exceeds a predetermined capacity, the CPU 105 expels the oldest Key-Value selected by using the LRU algorithm (A3). The Key-Value overflowed from the first hash cache is not discarded but stored in the corresponding bundle in the second hash cache to be left on the drive 31 (A4) (see FIGS. 3 and 4). Accordingly, it is possible to enhance the efficiency of data redundancy elimination without increasing the size of the first hash cache on the memory 106. In the second hash cache on the drive 31, as described above, the reference count of the unit data corresponding to the hash value is registered and saved, and the entries within each bundle of the second hash cache are sorted in descending order of the reference count.

The entries in each bundle of the second hash cache are divided into upper-level entries having a larger number of reference counts and a higher degree of redundancy and lower-level entries (that is, having a smaller number of reference counts and a lower degree of redundancy) except for the upper-level entries. The division into the upper-level entries and the lower-level entries may be performed according to whether the number of reference counts is greater than or equal to a criterion value. Alternatively, a criterion number of entries in the upper-level side having a larger number of reference counts may be regarded as the upper-level entries, and the entries except for those entries may be regarded as the lower-level entries. The CPU 105 prepares the upper-level BF with which the filtering is performed to filter only the upper-level entries and the lower-level BF with which the filtering is performed to filter only the lower-level entries, for each bundle. The prepared upper-level BF and the lower-level BF are saved on the drive 31, and furthermore, the upper-level BF is copied to the memory area 164 on the memory 106 to be saved (A5) (see FIGS. 3 and 4).

Accordingly, in a case where the searched hash value is not included in the search bundle of the first hash cache, the CPU 105 may allow the searched hash value to pass through the upper-level BF for the search bundle on the memory 106. Accordingly, the CPU 105 may determine whether the searched hash value is included in the upper-level entries of the corresponding bundle in the second hash cache on the drive 31, without accessing the drive 31. As such, the upper-level BF for the unit data having the higher degree of redundancy is loaded onto memory 106 so that an access amount to the drive 31 becomes smaller, thereby contributing to the enhancement of the storage performance, compared with a case where the upper-level BF is not loaded onto the memory 106.

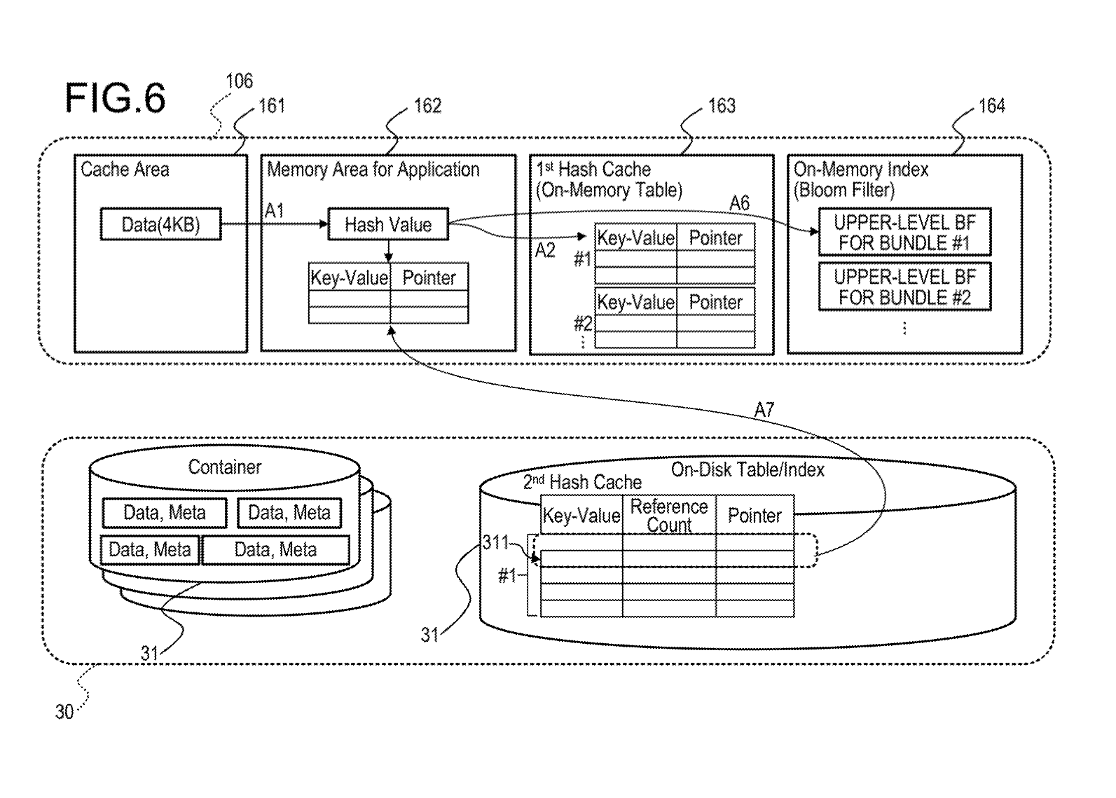

Next, descriptions will be made on operations of the CM 100 when the unit data to be written is received from the host apparatus 2 and written into the drive 31 (during a write sequence) with reference to FIG. 6. As illustrated in FIG. 6, when the unit data to be written is received from the host apparatus 2 and stored in the cache area 161 on the memory 106, the hash value of the unit data to be written is generated by the CPU 105 and saved in the memory area 162 for application (A1). Then, the remainder operation of the hash value is performed by the CPU 105, the search bundle for the hash value is determined, and the search bundle in the first hash cache on the memory 106 is searched for the searched hash value (A2).

In a case where the searched hash value is not present in the first hash cache on the memory 106, the CPU 105 allows the searched hash value to pass through the upper-level BF for the search bundle. The CPU 105 may determine whether the searched hash value is included in the upper-level entries of the corresponding bundle in the second hash cache on the drive 31, without accessing the drive 31 (A6).

In a case where the positive determination that the searched hash value is present in the drive 31 is obtained as the result of allowing the searched hash value to pass through the upper-level BF, it may be an erroneous detection by false positive. For that reason, the CPU 105 reads the upper-level entries (Key-Values) of the corresponding bundle from the second hash cache on the drive 31 onto the memory area 162 for application on the memory 106 (A7). Then, the CPU 105 searches for the searched hash value among the read upper-level entries to check whether any of the hash values in the upper-level entries matches the searched hash value.

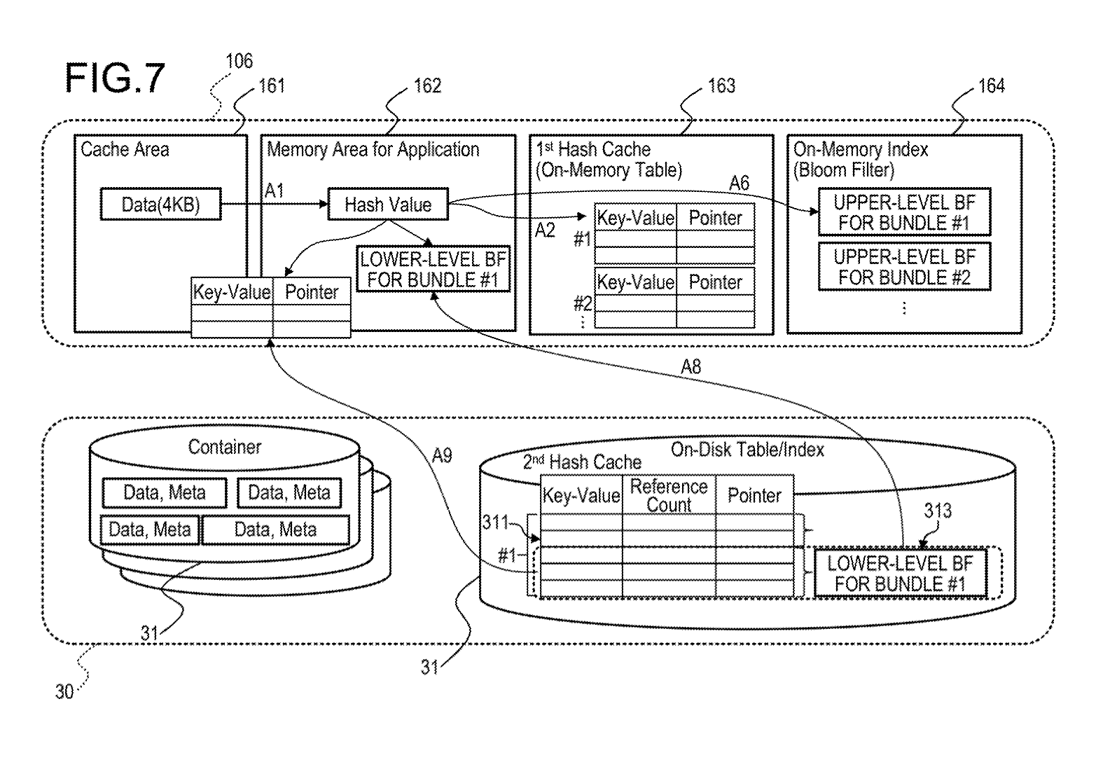

Next, descriptions will be made on operations of the CM 100 with reference to FIG. 7, in a case where the negative determination that the searched hash value is not present in the drive 31 is obtained as the result of allowing the searched hash value to pass through the upper-level BF for the search bundle on the memory 106 in FIG. 6.

In a case where the negative determination is obtained as the result of allowing the searched hash value to pass through the upper-level BF on the memory 106, as illustrated in FIG. 7, the CPU 105 reads the lower-level BF for the corresponding bundle from the memory area 313 on the drive 31 onto the memory area 162 for application on the memory 106 (A8). Then, the CPU 105 allows the searched hash value to pass through the read lower-level BF for the corresponding bundle to determine whether the searched hash value is included in the lower-level entries of the second hash cache on the drive 31. In FIG. 7, an example in which the search bundle (the corresponding bundle) is the bundle #1 is illustrated.

In a case where the positive determination that the searched hash value is present in the drive 31 is obtained as the result of allowing the searched hash value to pass through the lower-level BF, it may be an erroneous detection by false positive. For that reason, the CPU 105 reads the lower-level entries of the corresponding bundle from the second hash cache on the drive 31 onto the memory area 162 for application on the memory 106 (A9). Then, the CPU 105 searches for the searched hash value among the read lower-level entries to check whether any of the hash values in the lower-level entries matches the searched hash value.

As described above, in FIG. 7, in a case where the negative determination that the searched hash value is not present in the drive 31 is obtained using the upper-level BF for the search bundle on the memory 106, the CPU 105 accesses the drive 31, and searches for the searched hash value among the lower-level entries. Accordingly, further improvement in the redundancy elimination efficiency may be realized.

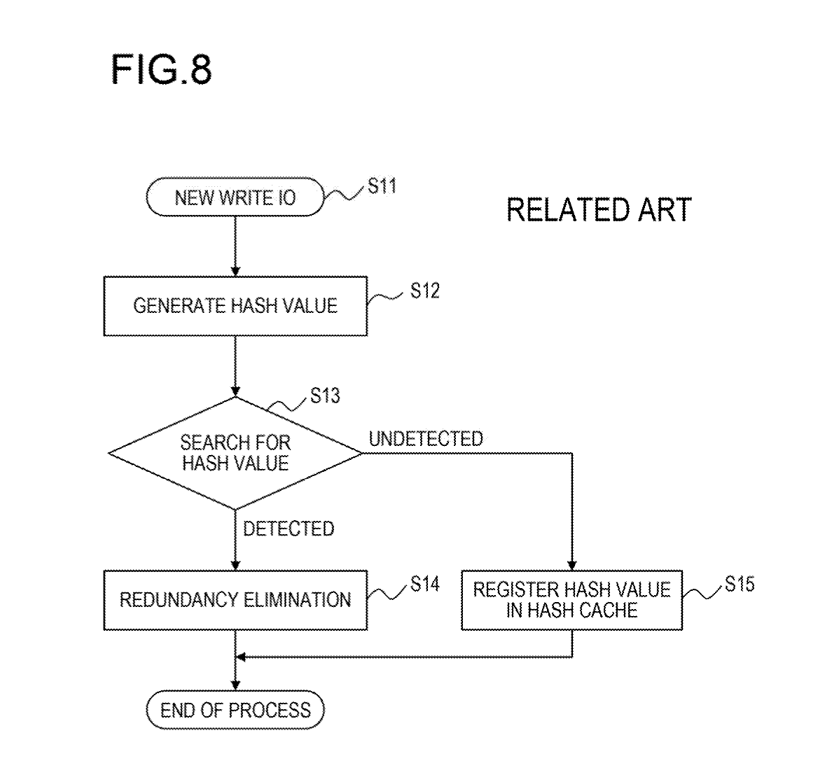

Descriptions will be made on a redundancy elimination search procedure according to a related technique, which is compared with the embodiment with reference to a flowchart illustrated in FIG. 8.

As illustrated in FIG. 8, in the redundancy elimination search procedure according to the related technique, when a CM (CPU) receives a new write IO from a host apparatus (S11), the CM generates a hash value for each unit data (chunk) of, for example, 4 KB (S12). Then, the CM searches a hash cache (on-memory table) for the generated hash value to detect whether the hash value is present or absent (match/mismatch) in the hash cache (S13). At this time, the CM performs the remainder operation of the hash value, determines a search bundle in the hash cache, and searches the inside of the determined search bundle for the hash value.

In a case where the hash value is present in the search bundle (“detected” at S13), the CM determines that data which is redundant with the unit data to be written is present on a storage device (storage). That is, the CM determines that redundancy is detected and performs redundancy elimination (S14).

In a case where the hash value is not present in the search bundle (“undetected” at S13), the CM determines that data, which is redundant with the unit data to be written, is not present on the storage device (drive). That is, the CM determines that redundancy is not detected and registers, as a new object to be searched for redundancy elimination, the hash value in the hash cache (on-memory table) (S15).

In a case where an empty entry does not exist in the search bundle of the hash cache (a case of full capacity), the CM expels the oldest hash value to be discarded by using the LRU algorithm, and then registers, in the hash cache, the hash value (new hash value) of the unit data to be written this time. Expelling and discarding the oldest hash value by using the LRU algorithm as described above allows the size of the hash cache (table) to be decreased. However, the discarded hash value does not serves as an object to be searched for at the time of the hash value search for the next write ICI, and thus, a possibility of detecting the data redundancy regarding the unit data to be written for the next write IO becomes lower. As a result, the efficiency of the data redundancy elimination is reduced, and thus, it is unable to efficiently use the limited storage capacity.

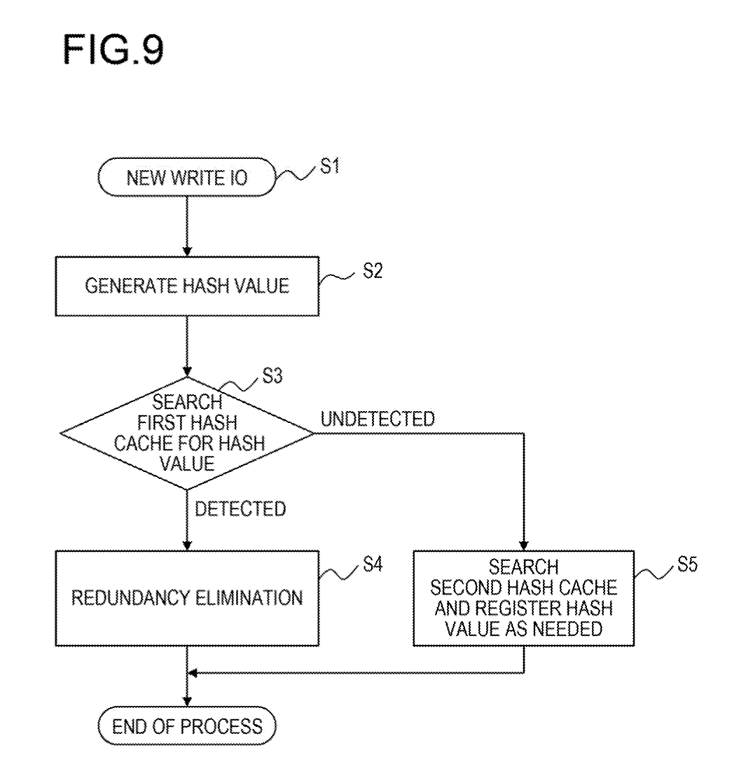

In contrast, according to the embodiment, it is possible to perform redundancy elimination search for all of unit data stored in the drive 31 such that the efficiency of the data redundancy elimination is improved without increasing the size of the memory area 163 for the first hash cache. Accordingly, the redundancy elimination search is performed in line with the sequence as described in the following without discarding the hash value expelled from the first hash cache (on-memory table). Hereinafter, descriptions will be made on the redundancy elimination search procedure according to the embodiment with reference to the flowcharts illustrated in FIGS. 9 to 11.

In the redundancy elimination search procedure according to the embodiment, when the CPU 105 receives a new write IO from the host apparatus 2 and saves the new write IO in the cache area 161 (S1 in FIG. 9), the CPU 105 (hash value generation unit 153) generates a searched hash value for each unit data (chunk) of, for example, 4 KB (S2 in FIG. 9). The CPU 105 (first determination unit 154) searches the hash cache (on-memory table) on the memory 106 for the searched hash value to detect whether the hash value is present or absent (match/mismatch) in the hash cache (S3 in FIG. 9). At this time, the CPU 105 performs the remainder operation of the hash value, determines the search bundle in the hash cache, and searches the inside of the determined search bundle for the hash value.

In a case where the hash value is present in the search bundle (“detected” at S3), the CPU 105 determines that data which is redundant with the unit data to be written is present on the drive 31 and that redundancy is detected. Accordingly, the CPU 105 (redundancy elimination unit 157) performs the redundancy elimination (S4 in FIG. 9). Then, the CPU 105 ends the redundancy elimination search procedure.

In a case where the hash value is not present in the search bundle (“undetected” at S3), the CPU 105 determines that data which is redundant with the unit data to be written is not present on the drive 31 and that redundancy is not detected. Accordingly, the CPU 105 searches the corresponding bundle of the second hash cache (on-disk table) on the drive 31 for the searched hash value, and performs registration of the searched hash value as needed (S5 in FIG. 9). Then, the CPU 105 ends the redundancy elimination search procedure.

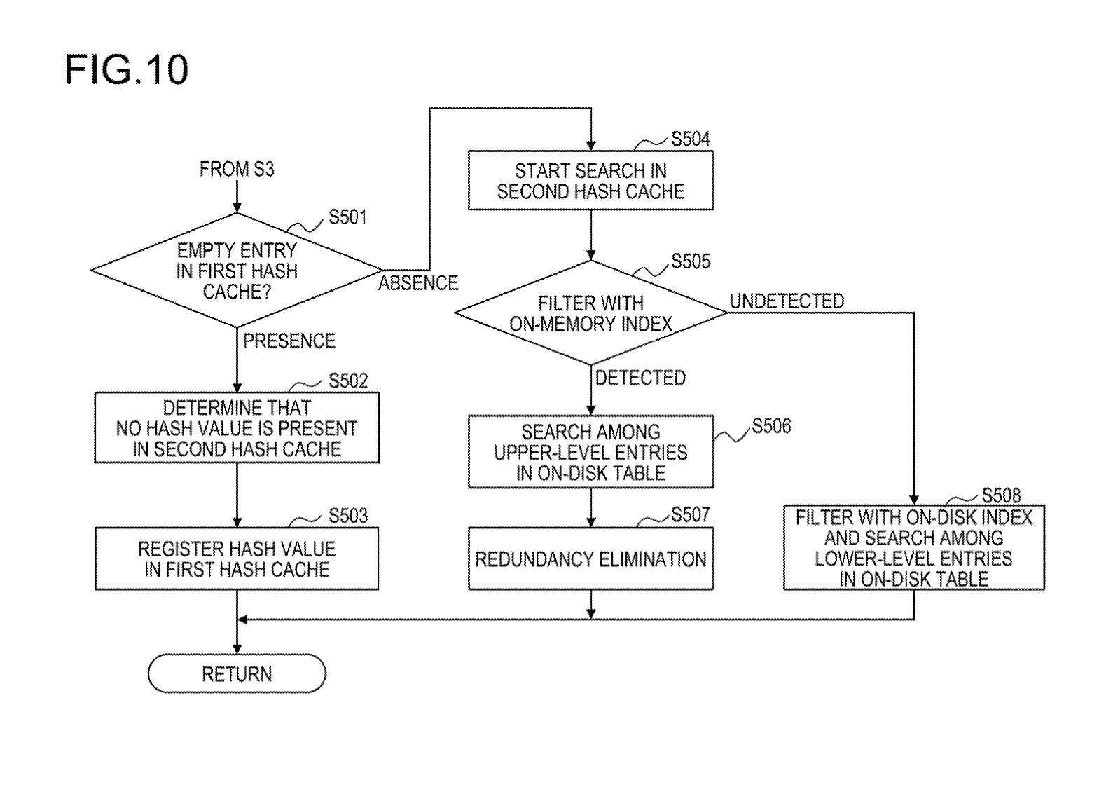

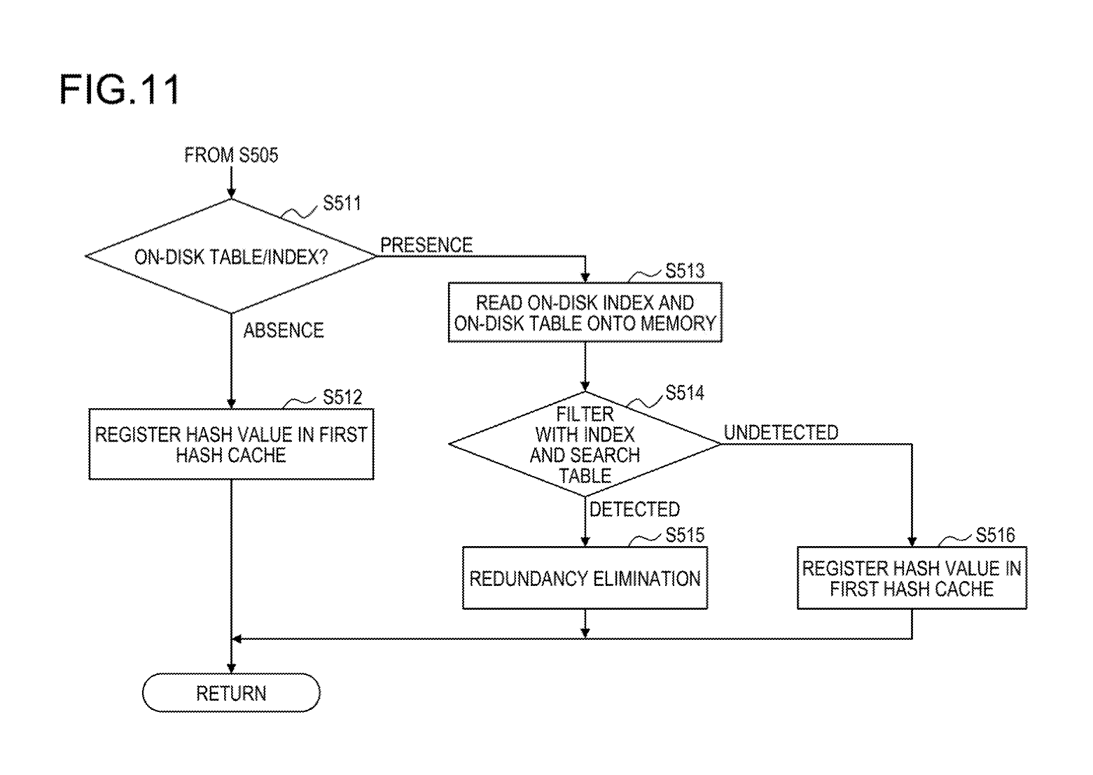

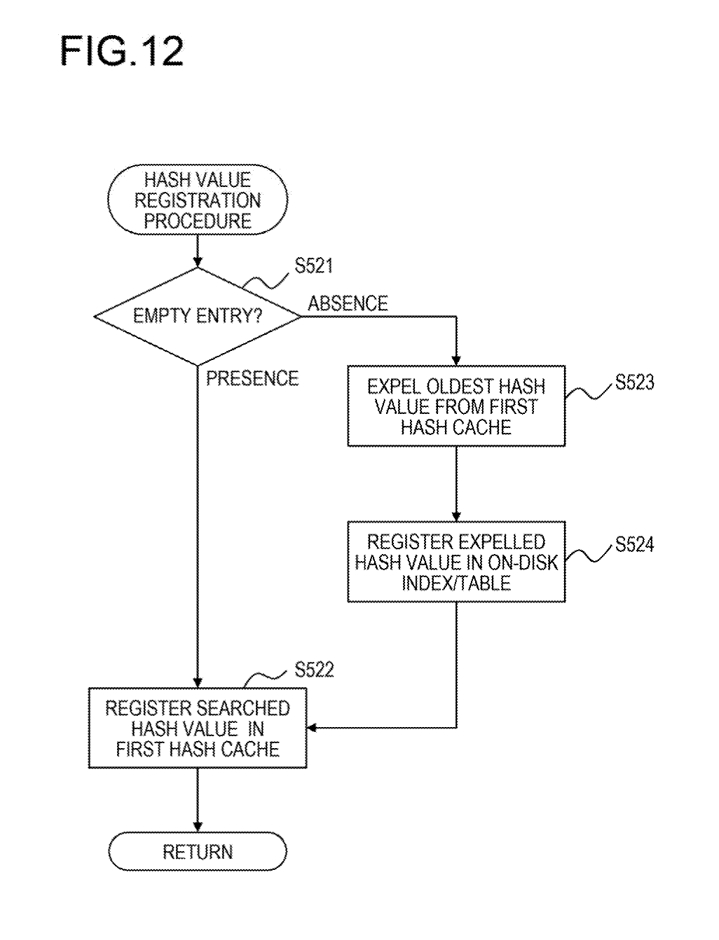

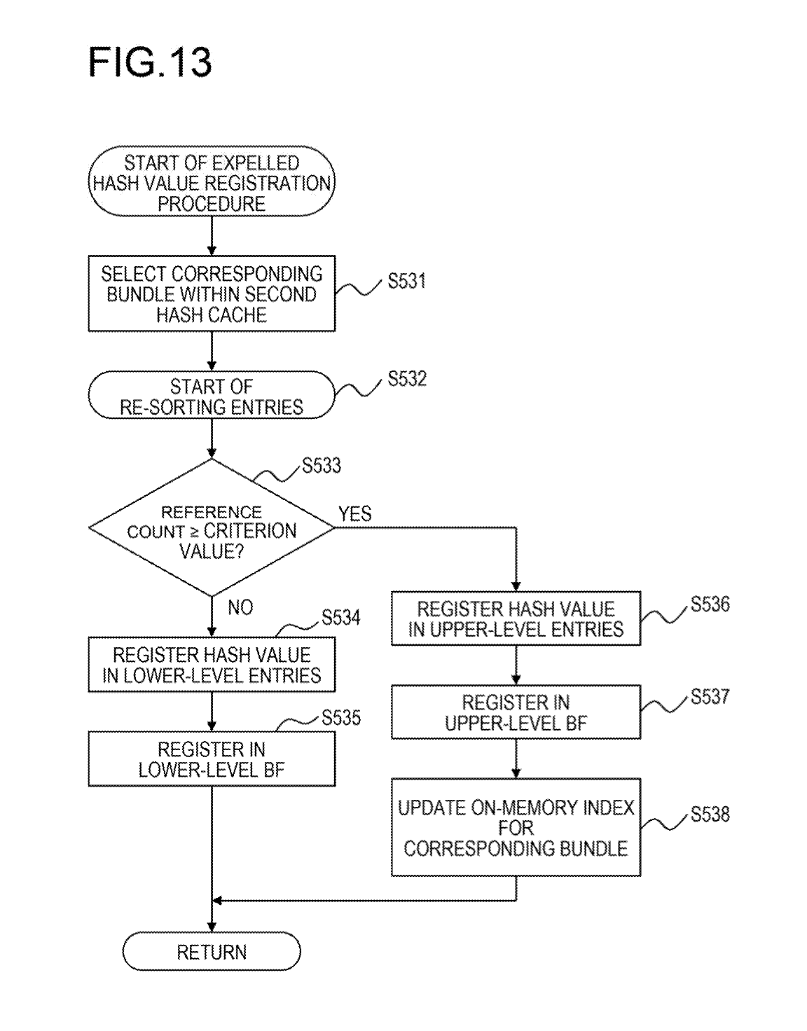

At this time, the CPU 105 determines whether the searched hash value is present in the corresponding bundle of the second hash cache using the upper-level BF (on-memory index) for the search bundle on the memory 106 or the lower-level BF (on-disk index) for the corresponding bundle on the drive 31. A search sequence of, for example, the second hash cache on the drive 31 will be described later with reference to FIGS. 10 and 11. A registration procedure of the searched hash value will be described later with reference to FIGS. 12 and 13.

Next, descriptions will be made on the redundancy elimination search procedure at S5 in FIG. 9 with reference to the flowchart illustrated in FIGS. 10 and 11.

First, the CPU 105 determines whether an empty entry is present or absent in the search bundle of the first hash cache on the memory 106 (S501).

In a case where it is determined that an empty entry is present (“presence” at S501), the CPU 105 may determine that the second hash cache on the drive 31 is unused, and no hash value is present in the second hash cache (S502). Accordingly, the CPU 105 determines that data, which is redundant with the unit data to be written, is not present on the drive 31 and that redundancy is not detected, and registers the searched hash value in the first hash cache on the memory 106 without performing further search using the searched hash value. In this case, the CPU 105 (first arrangement control unit 151 and second arrangement control unit 152) registers, as a new object to be searched for redundancy elimination, the searched hash value in the search bundle of the first hash cache (on-memory table) on the memory 106 (S503). A sequence of the registration will be described later with reference to FIGS. 12 and 13. Thereafter, the CPU 105 ends the redundancy elimination search procedure.

In a case where it is determined that no empty entry is present (“absence” at S501), it is determined that a bundle corresponding to the search bundle is present in the second hash cache on the drive 31. Accordingly, the search in the second hash cache is started (S504 in FIG. 10). At this time, the CPU 105 (second determination unit 155), first allows the searched hash value to pass through the upper-level BF (on-memory index) for the search bundle on the memory 106 to determine whether the searched hash value is included in the upper-level entries of the second hash cache on the drive 31 (S505).

When it is determined that the searched hash value is included in the upper-level entries of the second hash cache by using the upper-level BF (in a case of positive determination; “detected” at S505), it may be an erroneous detection by false positive, as described above. For that reason, the CPU 105 (second determination unit 155) reads the upper-level entries (on-disk table) of the corresponding bundle from the second hash cache on the drive 31 onto the memory area 162 for application on the memory 106 (A7 in FIG. 6). The CPU 105 (second determination unit 155) searches for the searched hash value among the read upper-level entries to check whether any of the hash values in the upper-level entries matches the searched hash value (S506).

After the check, the CPU 105 determines that data which is redundant with the unit data to be written is present on the drive 31 and that redundancy is detected. Accordingly, the CPU 105 (redundancy elimination unit 157) performs the redundancy elimination (S507). Thereafter, the CPU 105 ends the redundancy elimination search procedure.

When it is determined that the searched hash value is not included in the upper-level entries of the second hash cache by using the upper-level BF (in a case of negative determination; “undetected” at S505), the CPU 105 determines that the searched hash value is not present in the upper-level entries of the second hash cache. Then, the CPU 105 (third determination unit 156) performs filtering with the lower-level BF (on-disk index) and search among the lower-level entries in the second hash cache (on-disk table) on the drive 31, regarding the searched hash value (S508). Thereafter, the CPU 105 ends the redundancy elimination search procedure.

Hereinafter, descriptions will be made on a search sequence at S508 in FIG. 10 with reference to FIG. 11. First, the CPU 105 (third determination unit 156) determines whether the BF (index information) and the second hash cache (search table) for the lower-level entries are present on the drive 31, that is, on-disk table/index is present or not (S511).

In a case where it is determined that the lower-level BF and the second hash cache for the lower-level entries are not present (“absence” at S511) or a case where the second hash cache is in an empty state and thus it is unable to search for the searched hash value, the CPU 105 operates as follows. That is, the CPU 105 may determine that the lower-level BF or the lower-level entries of the second hash cache is unregistered, and the searched hash value is not present on the drive 31.

Accordingly, the CPU 105 determines that data which is redundant with the unit data to be written is not present on the drive 31 and that the redundancy is undetected, and registers the searched hash value in the first hash cache on the memory 106. In this case, the CPU 105 (first arrangement control unit 151 and second arrangement control unit 152) registers, as a new object to be searched for the redundancy elimination, the searched hash value in the search bundle of the first hash cache (on-memory table) on the memory 106 (S512). A sequence of the registration will be described later with reference to FIGS. 12 and 13. Thereafter, the CPU 105 ends the redundancy elimination search procedure.

In a case where the lower-level BF and the second hash cache for the lower-level entries are present (“presence” at S511), the CPU 105 operates as follows. That is, the CPU 105 reads the lower-level BF for the corresponding bundle and the lower-level entries of the corresponding bundle on the drive 31 onto the memory area 162 for application on the memory 106 (S513; A8 and A9 in FIG. 7).

Then, the CPU 105 (third determination unit 156) allows the searched hash value to pass through the lower-level BF (on-disk index) for the corresponding bundle, which is read onto the memory 106, to determine whether the searched hash value is included in the lower-level entries of the second hash cache on the drive 31. When it is determined that the searched hash value is included in the lower-level entries of the second hash cache by using the lower-level BF (in a case of positive determination), it may be an erroneous detection by false positive, as described above. For that reason, the CPU 105 (third determination unit 156) searches for the searched hash value among the lower-level entries of the corresponding bundle read onto the memory 106 to check whether any of the hash values in the lower-level entries matches the searched hash value (S514).

After the check (“detected” at S514), the CPU 105 determines that data which is redundant with the unit data to be written is present on the drive 31 and that redundancy is detected. Accordingly, the CPU 105 (redundancy elimination unit 157) performs the redundancy elimination (S515). Thereafter, the CPU 105 ends the redundancy elimination search procedure.

When it is determined that the searched hash value is not included in the lower-level entries of the second hash cache by using the lower-level BF (in a case of negative determination; “undetected” at S514), the CPU 105 determines that the searched hash value is not present in the lower-level entries of the second hash cache. Accordingly, the CPU 105 (third determination unit 156) determines that data which is redundant with the unit data to be written is not present on the drive 31 and that redundancy is undetected, and registers the searched hash value in the first hash cache on the memory 106. At this time, the CPU 105 (first arrangement control unit 151 and second arrangement control unit 152) registers, as a new object to be searched for the redundancy elimination, the searched hash value in the search bundle of the first hash cache (on-memory table) on the memory (S516). A sequence of the registration will be described later with reference to FIGS. 12 and 13. Thereafter, the CPU 105 ends the redundancy elimination search procedure.

In the sequence illustrated in FIG. 11, although both of the lower-level BF for the corresponding bundle and the lower-level entries of the corresponding bundle are read onto the memory 106 at S513, the lower-level BF for the corresponding bundle and the lower-level entries of the corresponding bundle may be read separately. That is, as illustrated in FIG. 7, first, the lower-level BF for the corresponding bundle is read, and the searched hash value is allowed to pass through the read lower-level BF, and in a case where a positive determination is obtained, the lower-level entries of the corresponding bundle may be read. In this case, when a negative determination is obtained by allowing the searched hash value to pass through the read lower-level BF, it does not need to read the lower-level entries of the corresponding bundle. Therefore, it is possible to reduce the amount of access to the drive 31 and suppress performance degradation of the storage.

Next, descriptions will be made on a hash value registration procedure according to the embodiment with reference to the flowcharts illustrated in FIGS. 12 and 13. The hash value registration procedure is processing sequence performed at S503 in FIG. 10 and S512 and S516 in FIG. 11.

First, the CPU 105 (first determination unit 154) determines whether an empty entry exists in the search bundle of the first hash cache on the memory 106 (S521). At this time, the CPU 105 performs the remainder operation of the searched hash value, determines the search bundle, and checks respective entries within the determined search bundle by following the pointers. In a case where it is determined that an empty entry is present (“presence” at S521), the CPU 105 (first arrangement control unit 151) additionally registers the searched hash value in the empty entry of the search bundle in the first hash cache (S522). Thereafter, the CPU 105 ends the redundancy elimination search procedure.

In a case where it is determined that no empty entry is present (“absence” at S521), the CPU 105 expels the hash value (Key-Value) in the oldest entry from the first hash cache by using the LRU algorithm (S523). The CPU 105 does not discard the expelled hash value (Key-Value) but registers the expelled hash value (Key-Value) in the index information (upper-level BF or lower-level BF) for the corresponding bundle and the corresponding bundle of the second hash cache on the drive 31 (S524). Hereinafter, the hash value expelled from the first hash cache is referred to as an expelled hash value.

Then, the CPU 105 (first arrangement control unit 151) registers the searched hash value in the entry from which the hash value is expelled and links the entry in which the searched hash value is registered to the bottom-end by rewriting the pointers in the first hash cache (S522). Thereafter, the CPU 105 ends the redundancy elimination search procedure.

Hereinafter, descriptions will be made on processing sequence at S524 in FIG. 12 with reference to FIG. 13.

First, the CPU 105 (second arrangement control unit 152) selects a bundle determined by the remainder operation of the expelled hash value from the bundles within the second hash cache on the drive 31 (S531). Thereafter, the CPU 105 (second arrangement control unit 152) performs re-sorting of the entries in each bundle in accordance with the reference count as follows (S532).

The CPU 105 refers to the reference count regarding the unit data which corresponds to the expelled hash value in order to determine which of the upper-level entries and the lower-level entries of the second hash cache the expelled hash value is to be registered in. The reference count is saved in the predetermined container (drive 31) as described above. Then, the CPU 105 compares the referred-to reference count with the criterion value (S533).

In a case where the value of the referred-to reference count of the expelled hash value is less than the criterion value (“NO” at S533), the CPU 105 additionally registers the expelled hash value in the lower-level entries of the second hash cache and updates the pointers of the lower-level entries (S534). The CPU 105 registers the expelled hash value in the lower-level BF for the corresponding bundle to update the lower-level BF for the corresponding bundle on the drive 31 (S535). At this time, registration of the expelled hash value in the lower-level BF for the corresponding bundle is performed by preparing a lower-level BF for filtering lower-level entries including the expelled hash value. Thereafter, the CPU 105 ends the expelled hash value registration procedure.

In a case where a value of the referred-to reference count of the expelled hash value is greater than or equal to the criterion value (“YES” at S533), the CPU 105 additionally registers the expelled hash value in the upper-level entries of the second hash cache and updates the pointers of the upper-level entries (S536). Then, the CPU 105 registers the expelled hash value in the upper-level BF for the corresponding bundle to update the upper-level BF for the corresponding bundle on the drive 31 (S537). At this time, registration of the expelled hash value in the upper-level BF for the corresponding bundle is performed by preparing an upper-level BF for filtering upper-level entries including the expelled hash value. Thereafter, the CPU 105 ends the expelled hash value registration procedure. Furthermore, the CPU 105 updates the upper-level BF for the corresponding bundle on the memory 106 with the upper-level BF for the new bundle prepared at S537 (S538). Thereafter, the CPU 105 ends the expelled hash value registration procedure.

The present disclosure is not limited to the specific embodiment described above, and may be embodied by adopting various changes and modifications in a range without departing from a gist of the present disclosure.

In the embodiment described above, although the upper-level BF for the bundles on the memory 106 is updated in a case where the expelled hash value is additionally registered in the upper-level entries of the second hash cache (S538 in FIG. 13), the present disclosure is not limited thereto. For example, the CPU 105 may move a hash value, of which the reference count is larger but access frequency is smaller, from the upper-level entries to the lower-level entries in each bundle every elapse of a predetermined time. In this case, the CPU 105 prepares the upper-level BF and the lower-level BF for the entries after the hash value is moved and updates the upper-level BF on the memory 106. Accordingly, it is possible to further enhance the efficiency of the redundancy elimination without increasing the size of the first hash cache on the memory 106.

Furthermore, in a case where the searched hash value matches (cache hit) with a hash value registered in the second hash cache, the CPU 105 may move the hash value which is hit from the entries (upper-level entries or lower-level entries) of the second hash cache to the memory 106. In this case, the CPU 105 performs the hash value registration procedure described above with reference to FIGS. 12 and 13. Accordingly, it is possible to further enhance the efficiency of the redundancy elimination without increasing the size of the first hash cache on the memory 106.

Furthermore, the CPU 105 may pre-fetch a hash value of the related logical block addressing (LBA) and register the hash value in the hash cache. In his case, it is also possible to further enhance the efficiency of the redundancy elimination without increasing the size of the first hash cache on the memory 106.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A storage control device, comprising:
a first memory;
a second memory different from the first memory; and
a processor configured to
store, in a storage device, a reference count of each of a plurality of first unit data and each of a plurality of second unit data, the reference count indicating a number of times of writing the respective unit data in the storage device,
arrange first entries of first management information in a first memory area on the first memory, the first memory area having a predetermined size, the first entries each including a hash value and information indicating where corresponding one of the plurality of first unit data is stored in the storage device,
arrange second entries of second management information in a second memory area on the second memory, the second entries each including a hash value, information indicating where corresponding one of the plurality of second unit data is stored in the storage device, and the reference count regarding the corresponding one of the plurality of second unit data, and
arrange, in a third memory area on the first memory, index information for filtering hash values included in the second entries.

2. The storage control device according to claim 1, wherein the processor is configured to
arrange, as the index information, upper-level index information in the third memory area, the upper-level index information filtering hash values included in upper-level entries among the second entries, the upper-level entries including a reference count equal to or greater than a reference value.

3. The storage control device according to claim 2, wherein the processor is configured to
arrange lower-level index information in a fourth memory area on the second memory, the lower-level index information filtering hash values included in lower-level entries among the second entries, the lower-level entries including a reference count less than the reference value.

4. The storage control device according to claim 3, wherein
the first memory is a memory used for controlling the storage device,
the second memory is the storage device.

5. The storage control device according to claim 3, wherein the processor is configured to
generate a searched hash value of unit data to be written,
search the first management information for the generated searched hash value to determine whether the searched hash value is included in the first management information,
perform, when it is determined that the searched hash value is included in the first management information, a redundancy elimination procedure regarding the unit data to be written, the redundancy elimination procedure being a procedure for avoiding redundantly saving the unit data to be written,
allow, when it is determined that the searched hash value is not included in the first management information in a case where no empty entry exists in the first memory area, the searched hash value to pass through the upper-level index information to determine whether the searched hash value is included in the upper-level entries, and
perform, when it is determined that the searched hash value is included in the upper-level entries, the redundancy elimination procedure regarding the unit data to be written.

6. The storage control device according to claim 5, wherein the processor is configured to
allow, when it is determined that the searched hash value is not included in the upper-level entries, the searched hash value to pass through the lower-level index information to determine whether the searched hash value is included in the lower-level entries, and
perform, when it is determined that the searched hash value is included in the lower-level entries, the redundancy elimination procedure regarding the unit data to be written.

7. The storage control device according to claim 6, wherein the processor is configured to:
select a third entry from the first entries when it is determined that the searched hash value is not included in the lower-level entries,
acquire a first reference count of the third entry,
register the third entry in the second management information in association with the first reference count,
register the third entry in the upper-level index information, in a case where the first reference count is equal to or greater than the reference value, and
register the searched hash value in the first management information instead of the third entry.

8. The storage control device according to claim 7, wherein the processor is configured to
register the third entry in the lower-level index information in a case where the first reference count is less than the reference value.

9. The storage control device according to claim 5, wherein the processor is configured to
additionally register the searched hash value in the first management information when it is determined that the searched hash value is not included in the first management information in a case where an empty entry exists in the first memory area.

10. A non-transitory computer-readable recording medium having stored therein a program that causes a computer to execute a process, the process comprising:
storing, in a storage device, a reference count of each of a plurality of first unit data and each of a plurality of second unit data, the reference count indicating a number of times of writing the respective unit data in the storage device;
arranging first entries of first management information in a first memory area on a first memory, the first memory area having a predetermined size, the first entries each including a hash value and information indicating where corresponding one of the plurality of first unit data is stored in the storage device;
arranging second entries of second management information in a second memory area on a second memory different from the first memory, the second entries each including a hash value, information indicating where corresponding one of the plurality of second unit data is stored in the storage device, and the reference count regarding the corresponding one of the plurality of second unit data; and
arranging, in a third memory area on the first memory, index information for filtering hash values included in the second entries.

11. The non-transitory computer-readable recording medium according to claim 10, the process further comprising:
arranging, as the index information, upper-level index information in the third memory area, the upper-level index information filtering hash values included in upper-level entries among the second entries, the upper-level entries including a reference count equal to or greater than a reference value.

12. The non-transitory computer-readable recording medium according to claim 11, the process further comprising:
arranging lower-level index information in a fourth memory area on the second memory, the lower-level index information filtering hash values included in lower-level entries among the second entries, the lower-level entries including a reference count less than the reference value.

13. The non-transitory computer-readable recording medium according to claim 12, wherein
the first memory is a memory used for controlling the storage device, and
the second memory is the storage device.

14. The non-transitory computer-readable recording medium according to claim 12, the process further comprising:
generating a searched hash value of unit data to be written;
searching the first management information for the generated searched hash value to determine whether the searched hash value is included in the first management information;
performing, when it is determined that the searched hash value is included in the first management information, a redundancy elimination procedure regarding the unit data to be written, the redundancy elimination procedure being a procedure for avoiding redundantly saving the unit data to be written;
allowing, when it is determined that the searched hash value is not included in the first management information in a case where no empty entry exists in the first memory area, the searched hash value to pass through the upper-level index information to determine whether the searched hash value is included in the upper-level entries; and
performing, when it is determined that the searched hash value is included in the upper-level entries, the redundancy elimination procedure regarding the unit data to be written.

15. The non-transitory computer-readable recording medium according to claim 14, the process further comprising:
allowing, when it is determined that the searched hash value is not included in the upper-level entries, the searched hash value to pass through the lower-level index information to determine whether the searched hash value is included in the lower-level entries; and
performing, when it is determined that the searched hash value is included in the lower-level entries, the redundancy elimination procedure regarding the unit data to be written.

16. The non-transitory computer-readable recording medium according to claim 15, the process further comprising:
selecting a third entry from the first entries when it is determined that the searched hash value is not included in the lower-level entries;
acquiring a first reference count of the third entry;
registering the third entry in the second management information in association with the first reference count;
registering the third entry in the upper-level index information, in a case where the first reference count is equal to or greater than the reference value; and
registering the searched hash value in the first management information instead of the third entry.

17. The non-transitory computer-readable recording medium according to claim 16, the process further comprising:
registering the third entry in the lower-level index information in a case where the first reference count is less than the reference value.

18. The non-transitory computer-readable recording medium according to claim 14, the process further comprising:
additionally registering the searched hash value in the first management information when it is determined that the searched hash value is not included in the first management information in a case where an empty entry exists in the first memory area.
